(19) United States
(12) Patent Application Publication
(10) Pub. No.: US 2007/0107839 A1
(43) Pub. Date: May 17, 2007

(54) Decorative board with surface structure

(76) Inventor: Ake Sjoberg, Lund (SE)

Correspondence Address: STEVENS DAVIS MILLER & MOSHER, LLP, 1615 L STREET, NW, SUITE 850, WASHINGTON, DC, 20036, US

(21) Appl. No.: 11/579,153

(22) PCT Filed: Nov. 17, 2004
(86) PCT No.: PCT/SE04/01681

§ 371 Date: Oct. 31, 2006

(30) Foreign Application Priority Data
Nov. 17, 2003 (SE) 0303079-B

(51) Int. Cl. B32B 37/00

(52) U.S. Cl. 156/307.7; 156/250

(57) ABSTRACT

A process for the manufacturing of decorative boards with a surface structure. The decorative boards comprises a base layer, a decor layer and a wear layer, the wear layer comprising a sheet or web of cellulose impregnated with thermosetting resin. The base layer, the decor layer and the wear layer is laminate together under increased temperature and pressure. Predetermined portions of an uppermost surface of the wear layer of the laminate is after the lamination procedure treated in order to alter the surface properties.

### BACKGROUND OF THE INVENTION

1. Field of the Invention

The present invention relates to decorative boards with surface structure of the upper surface.

2. Description of Related Art

Products coated with thermosetting laminates are frequent today. They are foremost used where the demand for abrasion resistance is high, but also where resistance towards different chemicals and moisture is required. As an example of such products floors, floor beadings, table tops, work tops and wall panels can be mentioned.

The thermosetting laminate mostly consists of a number of base sheets with a decor sheet placed closest to the surface. The decor sheet can be provided with a desired decor or pattern. The most frequent patterns usually represent the image of different kinds of wood, or minerals such as marble or granite. The surface of the laminate can be provided with a structure during the laminating procedure which will make the decor more realistic. Press plates with structure or structure foils are frequently used when manufacturing such a laminate. A negative reproduction of the structure in the press plate or the foil will be imprinted into the laminate during the laminating procedure.

The structure suitably represents features characteristic for the pattern the decor represents in the laminate. The structure can be made coarse to simulate for example roughly planed stone, or smooth with randomly placed pits and micro cracks to simulate polished marble. A wood surface can for example be simulated by providing the surface with randomly placed thin oblong indentations which imitate pores. These indentations must be oriented in the direction of the growth of the simulated wood, which is indicated by the pattern of the grains, in order to make the result realistic.

It has for a long time been a great need to be able to manufacture a decorative thermosetting laminate with a decor pattern and a surface structure as exiting as the decor reproduced.

### SUMMARY OF THE INVENTION

According to the present invention the above mentioned needs have been met and a decorative board with a decorative surface has been achieved. The invention relates to a process for the manufacturing of decorative boards with a surface structure. The decorative boards comprises a base layer, a decor layer and a wear layer, the wear layer comprising cellulose and thermosetting resin. The invention is characterised in that the base layer, the decor layer and the wear layer is laminated together under increased temperature and pressure, that predetermined portions of an uppermost surface of the wear layer of the laminate after the lamination procedure is treated in order to alter the surface properties.

According to one embodiment of the invention the uppermost surface of the wear layer is provided with a low gloss surface during the lamination procedure. Predetermined portions of the uppermost surface the wear layer is then provided with a gloss surface after the lamination.

The gloss surface is suitably achieved through means of polishing or through means of chemical treatment.

The polishing may suitably be achieved through means of a mechanical polishing action, either by means of an axially or radially applied tool and a polishing agent. It is also possible to use a ultrasonic tool in a similar manner.

According to another embodiment of the invention the uppermost surface of the wear layer is provided with a gloss surface during the lamination procedure. Predetermined portions of the uppermost surface the wear layer is then provided with a low gloss surface after the lamination.

The low gloss surface is suitably achieved through means of buffing, chemical treatment, blasting, corona treatment, plasma treatment or combinations thereof.

It is advantageous to cut the decorative boards into panels or tiles and providing them with means for joining along the edges prior to being provided with the portions of glossy surface. It will hereby be possible to accurately match the position of the gloss surface portion so that once the panels and/or tiles are assembled a perfect match is achieved. This is of course also the case with panels and tiles provided portions of low gloss surface after the lamination procedure.

According to one embodiment of the invention a demarcation consisting of a 1-20 mm wide, preferably 3-10 mm wide, field were one surface structure gradually transforms into another surface structure. It is through this means possible to achieve a surface structure with a perfect match over the edges of adjacent boards and at the same time have a surface structure that allows a slight misalignment between the printed decor and the surface structure.

The upper surface is according to one embodiment of the invention provided with deeper structures selected from the group consisting of; groups of small oblong indentations, different grades of flat surface finish, ridges and recesses and combinations thereof. These deeper structures are suitably achieved during the lamination procedure.

The base layer suitably consists of a particle board or a fibre board. It may also, in some cases, be advantageous to apply one or more base layers of Kraft-paper impregnated with thermosetting resin arranged on top of, and constituting a part of, the base layer. The wear layer is preferably constituted of a so called overlay paper, placed on top of the decor paper. The overlay paper is suitably impregnated with melamine-formaldehyde resin. The wear layer is suitably also coated with hard particles selected from the group consisting of; silica, aluminium oxide, silicon carbide or a combination thereof, the particles having an average particle size in the range 1-100 μm in order to improve the wear resistance.

It will according to the present application be possible to post-treat the surface of the laminate in order to achieve a perfect match of certain aspects of the surface structure. Accordingly the surface structure may be described as incorporating deeper structure and more shallow structure. A deeper structure may be used for simulating for example pores and cracks in wood. They may also be used for simulating the effects of worn wood where the softer portions of the wood is worn away creating depressions. This effect can also be found in wood where moisture levels have been very high on occasion. The deeper structures may also be used to simulate fissures in minerals like stone, marble, granite and sandstone but also in ceramic materials. These deeper structures may simulate the surface of roughly planned stone, chisel marks in minerals or wood etc. The common theme for these, deeper structures, are that they have a difference in level which between highest and lowest point which is above 0.05 mm. These structures are advantageously achieved during the lamination procedure.

It is rather difficult to match these surface structures on a large board format so that when a number of tiles or panels are cut from this board, the surface structure will match over the edges, once the panels or tiles are joined together. It is therefore advantageous to provide the surface with additional structure features after the lamination procedure, most preferably after the cutting and milling process where the panels or tiles are provided with edges for joining. Once the panels or tiles have reached this format it will be possible to guide the position of the further structuring process with reference to corners and edges of said panels or tiles in order to achieve a perfect match. The surface may here be polished to increase the gloss rate of the surface or buffed to decrease the gloss rate.

A typical example of a simulation of a real product may be described in the following way in order to facilitate the understanding of the invention. A decor paper with a decor depicting weathered birch is impregnated with melamine formaldehyde resin which then is dried to a so-called B-stage. The decor paper is then arranged as on top of a base layer of HDF board. On top of this decor paper is arranged two layers of so-called overlay paper impregnated with melamine formaldehyde resin and sprinkled with aluminium oxide particles before drying the papers to a so called B-stage. The uppermost surface of the uppermost overlay has particles with an average particle size below 30 μm, while subjacent surfaces of the overlay papers incorporate larger particles, preferably in the range 50 μm to 150 μm. The described stack of one base layer, one decor layer and two overlay layers are then laminated together in a laminate press after having arranged a press plate or press foil on top of the overlay. The press foil or press plate is provided with a flat, low gloss surface together with narrow oblong protrusions. The protrusions of the press plate or press foil will in the finished laminate create narrow indentations simulating pores in wood. These indentations are suitably arranged to match the printed decor. After having laminated the different layers together under increased temperature and pressure the laminate press is opened and the press plate or press foil is separated from the laminate achieved. This laminate board is then cut into panels and provided with means for joining along the edges. The panels, now in the end user format, can now be provided with the final portions of the surface structure. Predetermined portions of the surface, for example portions corresponding to the darker portions of the birch decor is now polished to a higher gloss rate. This will create a very life like impression of oil treated birch. Real wood treated with oil will naturally have a higher gloss rate in resin rich portions of the wood as these portions does not absorb the oil to the same extent as the rest of the wood does.

As it is desirable to have a certain degree of matching between the printed decor and the surface structure it is advantageous to guide the polishing process by means of a camera reading the decor. The guiding operation may in addition incorporate an algorithm guiding the polishing operation in the area close to selected edges so that a matching between adjacent edges of assembled panels may be achieved.

This procedure may of course also be utilised when the printed decor depicts combinations of different materials like marquetry where different types of wood are used in combination, or even wood/mineral combinations. It will here be easy to, guided by the camera provide the different decor sections with a matching gloss grade to enhance the decorative effect.

Accordingly it will be possible to achieve life like simulation of surfaces when simulating different kinds of wood as for example oak, birch, beech, ash, cherry, maple, walnut, pine, rosewood, teak, mahogany and ebony as well as minerals like marble, granite, sandstone, soapstone and ceramic materials which also are popular reproductions. The surface structures use for simulating surfaces to mach the above materials may comprise narrow oblong indentations in the surface of 0.1-2 mm width and 0.02-1 mm depth which may simulates pores, and cracks of wood. Wood grain may be simulated by sweeping patterns of indentations of 1-25 mm width and 0.1-2 mm depth. It is also possible to provide the surface with combinations of gloss and flat surfaces in sections which additionally may be raised or recessed. It is of course also possible to create completely fantasy based patterns of surface structures.

The invention is not limited to the embodiments to the embodiments shown as these may be altered within the scope of the invention. It is for example possible to use other materials than melamine impregnated paper as a wear layer. It for example possible to use a cellulose/thermosetting amino-resin mixture, either in dry form or containing a solvent. This mixture may also contain hard particles as described earlier. It is also possible to use a thermosetting amino-resin/hard particle mixture which possibly also contains a filler. If one desires to handle the resin mixture in a liquid state it should also contain a solvent and possibly a gelling agent.

1. A process for the manufacturing of decorative boards with a surface structure, the decorative boards comprises a base layer, a decor layer and a wear layer, the wear layer comprising a thermosetting resin, the process comprising:
laminating the base layer, the decor layer and the wear layer together under increased temperature and pressure, and
treating portions of an uppermost surface of the wear layer of the laminate to alter the surface properties.

2. A process according to claim 1 comprising at least one of:
providing the uppermost surface of the wear layer with a low gloss surface during the lamination and
imparting portions of the uppermost surface the wear layer with a gloss surface after the lamination.

3. A process according to claim 2 wherein at least one of the providing and the imparting comprises polishing.

4. A process according to claim 2 wherein at least one of providing and the imparting comprises chemical treatment.

5. A process according to claim 1 comprising at least one of:
providing the uppermost surface of the wear layer with a gloss surface during the lamination and
imparting portions of the uppermost surface the wear layer with a low gloss surface after the lamination.

6. A process according to claim 5 wherein the imparting comprises buffing.

7. A process according to claim 5 wherein the imparting comprises chemical treatment.

8. A process according to claim 5 wherein the imparting comprises blasting.

9. A process according to claim 5 wherein the imparting comprises plasma treatment.

10. A process according to claim 5 wherein the imparting comprises corona treatment.

11. A process according to claim 2 further comprising cutting the decorative board into panels or tiles and providing at least one joining elements along an edge of the cut board prior to the imparting.

12. (canceled)

13. A process according to claim 2 wherein the base layer comprises one selected from the group consisting of particle board and fibre board.

14. A process according to claim 2 wherein the decorative board comprises a demarcation having a width of 1-20 mm where one surface structure gradually transforms into another surface structure.

15. A process according to claim 2 wherein the wear layer comprises an overlay paper on top of the decor paper.

16. A process according to claim 15 wherein the overlay paper is impregnated with melamine-formaldehyde resin.

17. A process according to claim 15 wherein the wear layer comprises hard particles selected from the group consisting of silica, aluminium oxide, silicon carbide or a combination thereof, the particles having an average particle size in the range 1-150 μm.

18. A process according to claim 2 further comprising creating at least one structure on the upper surface, the structures being selected from the group consisting of oblong indentations, different grades of flat surface finish, ridges and recesses and combinations thereof.

19. A process according to claim 18, wherein the creating is performed during the lamination.

20. A process according to claim 1, wherein the wear layer comprises cellulose.

21. A decorative board produced according to the process of claim 2.

22. A decorative board comprising:
a core;
a decorative layer on the core;
the decorative layer depicting a printed decor;
a wear layer over the decorative layer;
the wear layer comprises a high gloss surface.

23. The decorative board of claim 21, further comprising an area of low gloss.

24. The decorative board of claim 21, wherein the wear layer comprises a surface structure.

25. The decorative board of claim 21, wherein the surface structure matches the decor.
